(19) United States
(12) Patent Application Publication
(10) Pub. No.: US 2005/0268991 A1
(43) Pub. Date: Dec. 8, 2005

(54) Corrosion resistance enhancement of tin surfaces

(75) Inventors: Chonglun Fan, Bridgewater, NJ (US); Joseph A. Abys, Warren, NJ (US); Chen Xu, New Providence, NJ (US); Edward J. Kudrak JR., Morganville, NJ (US); Vincent Paneccasio JR., Madison, CT (US); Igor Zavarine, New Haven, CT (US); Christian Rietmann, Sonsbeck (DE)

Correspondence Address: SENNIGER POWERS LEAVITT AND ROEDEL, ONE METROPOLITAN SQUARE, 16TH FLOOR, ST LOUIS, MO, 63102, US

(73) Assignee: Enthone Inc.

(21) Appl. No.: 10/860,678

(22) Filed: Jun. 3, 2004

(51) Int. Cl. C04B 9/02; C25D 3/32; B05D 1/36; B05D 7/00; B05D 1/18

(52) U.S. Cl. 148/250; 427/402; 106/14.12

(57) ABSTRACT

A method for enhancing corrosion resistance of a tin-based surface on a workpiece involving contacting the tin-based surface with a composition comprising a phosphonic acid compound and water to form a phosphorus-based film over the tin-based coating thereby inhibiting corrosion of the tin-based surface. Phosphonic acid containing compositions having a concentration up to about 30 vol. % of an organic solvent, and water.

### FIELD OF THE INVENTION

This invention relates to methods and compositions for inhibiting corrosion of tin-based surfaces, and to inhibiting corrosion and enhancing solderability of such surfaces.

### BACKGROUND

Tin-based coatings are frequently applied to surfaces of copper- and nickel-based workpieces such as surfaces of electrical connectors, engineering, functional, and decorative devices in order to prevent the copper or nickel-based surface from oxidizing or tarnishing and/or to enhance solderability. Under conditions such as elevated temperatures in air or in other oxidizing atmospheres, tin-coated surfaces of electronic package leads and electrical connectors have a tendency to form oxide films during periods of shipment and storage between manufacture and assembly into electronic devices. The oxide coats, typically only about 50-200 Angstroms (Å) in thickness, discolor the surface of the tin-coated surface and impart a yellowish color which many consumers consider unacceptable. Furthermore, the oxide may degrade the contact resistance of a coated electrical terminal. A tarnish-free surface has lower electrical contact resistance and better solderability than an oxide coated surface.

S. Chen, et al., in U.S. Pat. No. 6,136,460 disclose approaches to reducing the oxidation of tin which involve inclusion of elements that have a more negative free energy of oxide formation than tin into the tin matrix. Such elements include potassium, sodium, calcium, chromium, manganese, magnesium, aluminum, vanadium, zinc, indium and phosphorus amongst several others. Such inclusion may be accomplished by electrolytic deposition of the element onto the tin surface, immersion of the surface in melts of the element, or immersion in salt solutions of the element followed by high temperature reflow techniques. The high temperature exposure renders the process unacceptable for certain temperature-sensitive applications, and increases processing time, cost, and equipment requirements.

H. E. Fuchs, et al., in U.S. Pat. No. 5,853,797 disclose a method and solution for providing corrosion protection of coated electrical contact surfaces which involve exposure of such surfaces to a solution containing phosphonates, lubricants and various volatile organic solvents. Evaporation of such solvents for disposal is fraught with environmental concerns such as handling, hazard to workers, and disposal of waste into streams.

The above approaches suffer from inherent disadvantages such as high processing temperatures, expense, and difficult solvents. Therefore, there is a need for a low temperature, environmentally friendly, and inexpensive method to provide an anti-tarnish, oxidation resistant, agent onto tin-based surfaces in order to provide protection against the yellowing and oxidation typically encountered by electrical terminals and connectors during storage and shipment. The present invention provides a solution to that need.

### SUMMARY OF THE INVENTION

Among the objects of the invention, therefore, is to provide a method and compositions for imparting corrosion resistance and enhancing solderability of a tin-based surface.

Briefly, therefore, the invention is directed to a method for enhancing corrosion resistance of a tin-based surface of a workpiece comprising contacting the tin-based surface with a composition comprising a phosphonic acid compound and water to form a phosphorus-based film over the tin-based coating thereby inhibiting corrosion of the tin-based surface.

The invention is also directed to various compositions for enhancing corrosion resistance of a tin-based surface on a workpiece comprising between about 0.01 and about 10% w/v of a phosphonic acid compound and water; and such compositions alternatively also containing a concentration up to about 30vol. % of an organic solvent.

Other objects and features of the invention are disclosed.

### BRIEF DESCRIPTION OF THE DRAWINGS

FIG. 1 is a cross-section of a lead formed according to this invention for an encapsulated electronic component.

FIG. 2 is an electronic packagage.

FIG. 3 is a lead frame.

FIG. 4 is an electrical connector.

FIGS. 5 and 6 are photographs of test pieces discussed in the examples.

FIG. 7 is a graphical representation of test data of the examples.

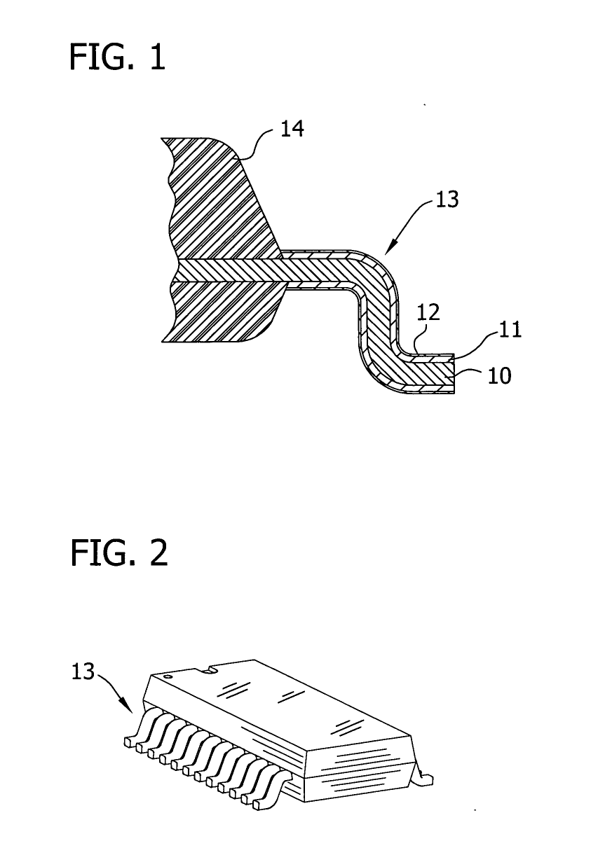

### FIGS. 1-4 are schematic and are not drawn to scale.

Corresponding reference characters indicate corresponding parts throughout the drawings.

### DETAILED DESCRIPTION OF PREFERRED EMBODIMENTS

In one aspect the invention is directed to a method for enhancing corrosion resistance of a tin-based surface of a workpiece. For purposes of illustration, one such workpiece is an electronic component such as an electronic lead of an encapsulated electronic package, or is an electrical connector; but the invention is applicable to any tin-based surface whether part of an electronic device, engineering, functional, decorative, or otherwise. With regard to tin-based surfaces for electronic devices, the method enhances corrosion resistance and also preserves solderability of tin-based surfaces during storage prior to a soldering operation involving reflow of a portion of the tin-based surface.

In accordance with the invention, the tin-based surface is immersed or otherwise contacted with a composition comprising a phosphonic acid compound and water to form a phosphorus-based film over the tin-based surface. This film inhibits corrosion of the tin-based surface. The water is preferably deionized. The phosphonic acid compound has the formula: 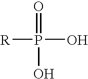
where R is hydrocarbyl or substituted hydrocarbyl and the H ions can be replaced by sodium or potassium to produce a phosphonate salt. In one embodiment, R is a long-chain linear or branched substituent and the H ions can be replaced by sodium or potassium to produce a phosphonate salt. In a preferred embodiment, the phosphonic acid compound is a phosphonic acid of the general formula CH₃(CH₂)ₙP(O)(OH)₂ wherein n is in the range 5 to 17. In one currently preferred embodiment, the composition contains octyl phosphonic acid as the phosphonic acid compound. It is believed that the PO₃⁻² moiety facilitates attachment of the compound to the substrate surface.

Unless otherwise indicated, the “substituted hydrocarbyl” moieties described herein are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. The hydrocarbyl moieties may be substituted with one or more of the following substituents: halogen, heterocyclo, alkoxy, alkenoxy, alkynoxy, aryloxy, hydroxy, protected hydroxy, hydroxycarbonyl, keto, acyl, acyloxy, nitro, amino, amido, nitro, phosphono, cyano, thiol, ketals, acetals, esters and ethers.

In general, the range of concentration of the phosphonic acid compound is about 0.01 to 10 weight/volume percent (wt./vol. %)(1 wt./vol. %=10 grams in 1 liter). Concentrations of less than 0.01 percent are not effective in corrosion protection, while concentrations above 10 weight percent tend to result in a material with too high a viscosity to be useful for most applications.

Among the various embodiments of the invention are methods which employ compositions comprising the phosphonic acid compound, water, and other optional components as might be desired under certain circumstances. There are other embodiments in which the compositions comprise the phosphonic acid compound, organic solvent, water, and other optional components as might be desired under certain circumstances. And there are other embodiments which consist essentially of these components, i.e., they contain no additional components which materially affect the basic properties of the invention. In the embodiments where components are specifically excluded, such exclusion is critical to achieving certain of the additional properties of those compositions, such as simplicity, low cost, predictability, reduction of risk of interactivity, and stability.

In one embodiment of the invention, organic solvents are employed to assist dissolving the phosphonic acid compound, but only to only a limited extent. In particular, the compositions of this embodiment contain no more than about 30% organic solvent by volume (vol. %), and in some embodiments, less than about 5% organic solvent by volume. The organic solvent may be an alcohol, and in one preferred embodiment, the organic solvent is ethanol. In this embodiment the foregoing concerns are substantially reduced. Advantageously, by keeping the concentration of such organic solvents at a low level, concerns such as handling, hazard to workers, disposal of waste into streams, flash point, and expense are substantially reduced.

In an alternative embodiment, the composition is essentially free of organic solvents. This embodiment contains the phosphonic acid compound and water. Advantageously, by eliminating organic solvents concerns with such solvents such as handling, hazard to workers, and disposal of waste into streams, and expense are eliminated.

The invention is also directed to concentrates containing much less water, which are to be diluted prior to use.

In performing the method of the invention, tin-based surfaces to be treated are exposed to the composition of the invention by immersion, cascading, spraying, or brushing. The exposure time in one embodiment is between about 1 sec and about 60 sec. The temperature of the composition is between about 20 C and about 45 C. The treated surfaces are normally not rinsed. In some cases, the surface may be rinsed to increase the brightness of the surface. However, this rinse can reduce the effectiveness of the film because it partially removes it. The composition is allowed to air dry on the surface to leave a thin phosphorus-based film estimated to be between about 5 Å and about 10000 Å thick.

After drying, the components are stored and/or shipped to a subsequent manufacturing operation where they are incorporated into an electronic device by a metals joining technique, i.e., soldering. Exposure of the treated surfaces to temperatures above about 230 C are specifically avoided between deposition of the film and such time as an actual manufacturing operation. In the manufacturing operation the tin surface is reflowed at a temperature above about 230 C as part of an assembly operation involving connection of the surfaces to a substrate of a device. Accordingly, the first exposure of the phosphorus film-bearing tin-based surface to a temperature above about 230 C is a joining operation.

In one aspect, the method of the invention involves a lead 13 (FIG. 1), which is a segment of any standard electronic package employing leads, e.g., the package displayed in FIG. 2.

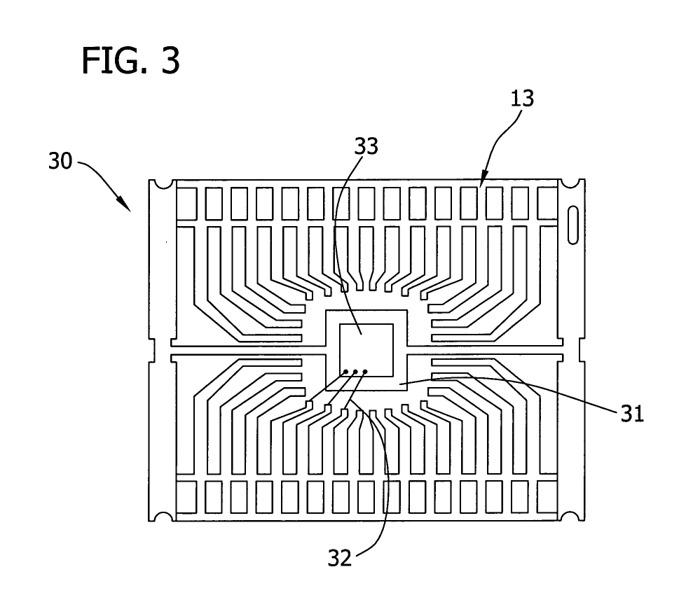

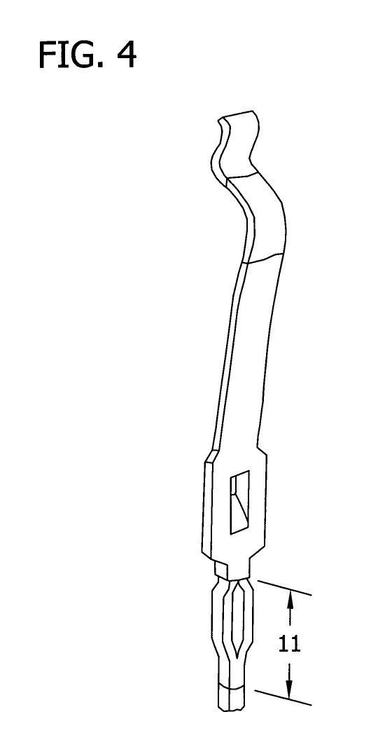

FIG. 1 shows a cross section of part of an electronic package 14 with a lead 13 having a conductive base metal 10, and a tin or tin alloy coating 11. The base metal may be copper, a copper alloy, iron, an iron alloy, or any other metal suitable for use in electronic components. A tin or tin alloy coating is applied to provide corrosion resistance and solderability to the metal feature. Examples of tin alloys employed include Sn—Bi, Sn—Cu, and Sn—Ag. The Sn coating 11 is typically applied to the exposed lead line 10 after application of encapsulation 14. Optionally, however, the Sn coating is applied earlier in the process, i.e., to the lead frame 30 shown in FIG. 3.

An electronic package of the type treated in accordance with one embodiment of the invention is manufactured in part from a lead frame 30 shown in FIG. 3. An electronic device 33 is positioned on a pad 31 and connected to leads 13 by wire bonds 32, prior to an encapsulation step which yields the package 14 in FIG. 1.

In another aspect, this invention encompasses an electronic connector as shown in FIG. 4. The Sn coating is typically applied to the exposed segment 11, and in accordance with the invention this is contacted with the phosphorus-containing composition of the invention.

These figures are schematic and the various respective layers are not drawn to scale.

Further details of the invention are given in the following examples.

### EXAMPLE 1

Copper sheets having a tin-based surface thereon were immersed in three distinct compositions of the invention in a balance of deionized water for about 10 seconds:
A—1.2 wt/vol % octylphosphonic acid; 22 vol % ethanol
AA—1.6 wt/vol % octylphosphonic acid; 0.2 vol % ethanol
AAA—1.6 wt/vol % octylphosphonic acid; 0% ethanol

These sheets, and a copper sheet with a tin-based surface thereon with no phosphorus-based composition treatment according to the invention, were exposed to steam aging under the conditions of 85 C and 85% relative humidity (RH). The samples were thereafter observed for discoloration (yellowish color) as follows, where X is the number of days until first observation of discoloration was made:

TABLE 1
Discoloration test results on tin coatings.

| Post-treatment | Days |
|---|---|
| No treatment | 0 < X ≦ 2 |
| A | 88 < X ≦ 106 |
| AA | 73 < X ≦ 91 |
| AAA | 73 < X ≦ 91 |

These results illustrate that with the method and compositions of the invention A, AA, and AAA, there was no noticeable discoloration even after two months.

### EXAMPLE 2

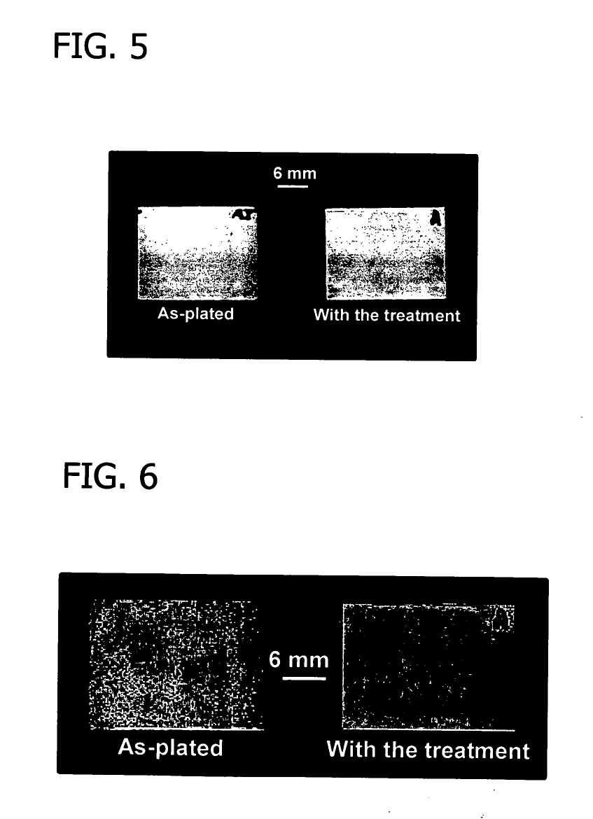

Photographs were taken of the as-plated copper sheet without the treatment of the invention, and of the copper sheet receiving the treatment of the invention with composition A by immersion for about 10 seconds. Photographs taken after 23 days of 85 C/85% RH steam aging are presented in FIG. 5. These illustrate discoloration in the as-plated sample and no discoloration in the sample treated according to the invention.

### EXAMPLE 3

Photographs were taken of the as-plated copper sheet without the treatment of the invention, and of the copper sheet receiving the treatment of the invention with composition A by immersion for 10 seconds. Photographs taken after 106 days of 85 C/85% RH steam aging are presented in FIG. 6. These illustrate severe corrosion in the as-plated sample and only minor discoloration at the edges in the sample treated according to the invention.

### EXAMPLE 4

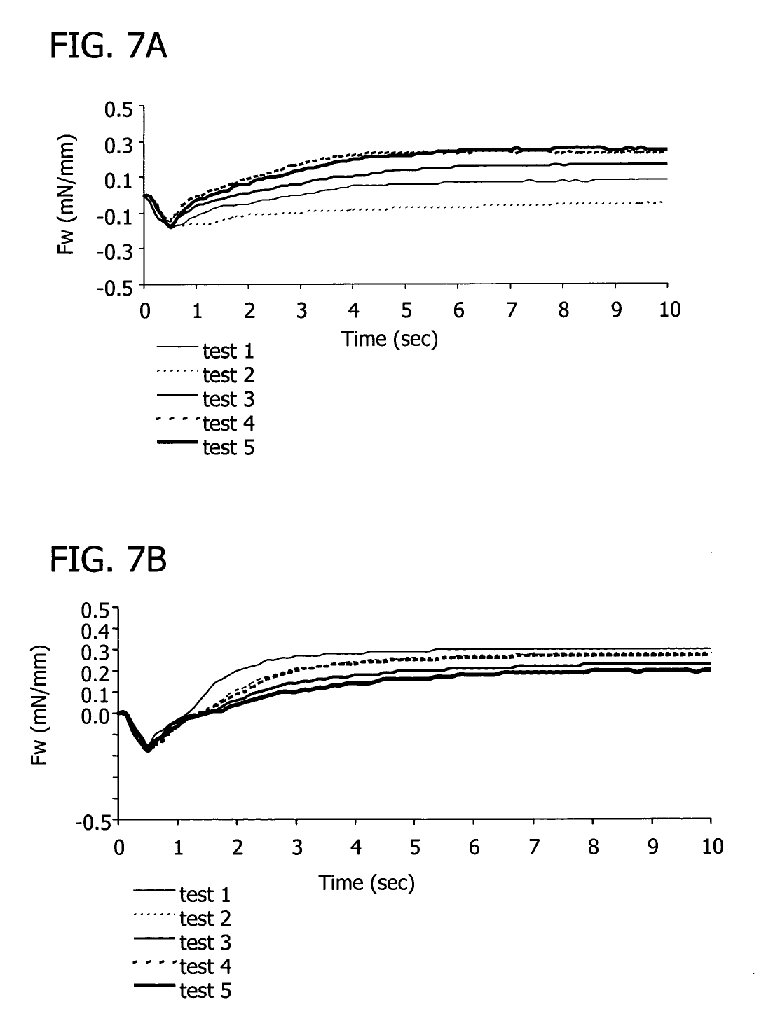

Tin-plated samples having undergone steam aging for 18 hours under the conditions of 85 C and 85% relative humidity were subjected to solderability wetting balance tests (Joint Industry Standard J-STD-002). The wetting balance test conditions were: Sn63Pb37 solder, 235 C, R-type non-activated flux. The results of five tests conducted on as-plated samples not receiving the treatment of the invention are presented in FIG. 7A. These results reveal a broad deviation of readings, and long wetting times (average zero cross time, ZCT>3.40 sec).

The results of five tests conducted on samples receiving the treatment of the invention (1.6 wt/vol % octylphosphonic acid in water and 0.2% ethanol) are presented in FIG. 7B. These results reveal that oxidation of the tin-based surface was alleviated. The samples provided relatively low wetting time readings (average ZCT=1.36±0.12 sec) and a narrow deviation of the readings after the steam aging. Treatment with the corrosion inhibiting material therefore significantly improved the wettability and solderability of the tin-based surfaces.

The present invention is not limited to the above embodiments and can be variously modified. The above description of preferred embodiments is intended only to acquaint others skilled in the art with the invention, its principles and its practical application so that others skilled in the art may adapt and apply the invention in its numerous forms, as may be best suited to the requirements of a particular use.

With reference to the use of the word(s) “comprise” or “comprises” or “comprising” in this entire specification (including the claims below), it is noted that unless the context requires otherwise, those words are used on the basis and clear understanding that they are to be interpreted inclusively, rather than exclusively, and that it is intended each of those words to be so interpreted in construing this entire specification.

1. A method for enhancing corrosion resistance of a tin-based surface on a workpiece comprising:
contacting the tin-based surface with a composition comprising a phosphonic acid compound and water to form a phosphorus-based film over the tin-based coating thereby inhibiting corrosion of the tin-based surface.

2. The method of claim 1 wherein the phosphonic acid compound has a structure of the following formula: 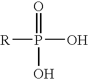
where R is hydrocarbyl or substituted hydrocarbyl and the H ions can be replaced by sodium or potassium to produce a phosphonate salt.

3. The method of claim 1 wherein the phosphonic acid compound has a structure of the following formula: 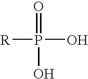
where R is a long-chain linear or branched substituent and the H ions can be replaced by sodium or potassium to produce a phosphonate salt.

4. The method of claim 1 wherein the phosphonic acid compound has the general formula CH₃(CH₂)ₙP(O)(OH)₂ wherein n is in the range 5 to 17.

5. The method of claim 1 wherein the phosphonic acid compound is octylphosphonic acid.

6. The method of claim 2 wherein the composition comprises:
the phosphonic acid compound;
an organic solvent in a concentration of less than about 30 vol. %; and
the water.

7. The method of claim 6 wherein the phosphonic acid compound has a general formula CH₃(CH₂)ₙP(O)(OH)₂ wherein n is in the range 5 to 17.

8. The method of claim 6 wherein the phosphonic acid compound is octylphosphonic acid.

9. The method of claim 2 wherein the composition comprises:
the phosphonic acid compound;
an organic solvent in a concentration of less than about 5 vol. %; and
the water.

10. The method of claim 9 wherein the phosphonic acid compound has a general formula CH₃(CH₂)ₙP(O)(OH)₂ wherein n is in the range 5 to 17.

11. The method of claim 9 wherein the phosphonic acid compound is octylphosphonic acid.

12. The method of claim 2 wherein the composition comprises:
the phosphonic acid compound;
an alcohol in a concentration of less than about 30 vol. %; and
the water.

13. The method of claim 12 wherein the phosphonic acid compound has a general formula CH₃(CH₂)ₙP(O)(OH)₂ wherein n is in the range 5 to 17.

14. The method of claim 12 wherein the phosphonic acid compound is octylphosphonic acid.

15. The method of claim 2 wherein the composition comprises:
the phosphonic acid compound;
an alcohol in a concentration of less than about 5 vol. %; and
the water.

16. The method of claim 15 wherein the phosphonic acid compound has a general formula CH₃(CH₂)ₙP(O)(OH)₂ wherein n is in the range 5 to 17.

17. The method of claim 15 wherein the phosphonic acid compound is octylphosphonic acid.

18. The method of claim 2 wherein the composition comprises:
the phosphonic acid compound;
ethanol in a concentration of less than about 30 vol. %; and
the water.

19. The method of claim 18 wherein the phosphonic acid compound has a general formula CH₃(CH₂)ₙP(O)(OH)₂ wherein n is in the range 5 to 17.

20. The method of claim 18 wherein the phosphonic acid compound is octylphosphonic acid.

21. The method of claim 2 wherein the composition comprises:
the phosphonic acid compound;
ethanol in a concentration of less than about 5 vol. %; and
the water.

22. The method of claim 21 wherein the phosphonic acid compound has a general formula CH₃(CH₂)ₙP(O)(OH)₂ wherein n is in the range 5 to 17.

23. The method of claim 21 wherein the phosphonic acid compound is octylphosphonic acid.

24. The method of claim 2 wherein the composition is free of organic solvent and comprises the phosphonic acid and the water.

25. The method of claim 24 wherein the phosphonic acid compound has a general formula CH₃(CH₂)ₙP(O)(OH)₂ wherein n is in the range 5 to 17.

26. The method of claim 24 wherein the phosphonic acid compound is octylphosphonic acid.

27. The method of claim 2 wherein the composition consists essentially of the phosphonic acid and the water.

28. The method of claim 27 wherein the phosphonic acid compound has a general formula CH₃(CH₂)ₙP(O)(OH)₂ wherein n is in the range 5 to 17.

29. The method of claim 27 wherein the phosphonic acid compound is octylphosphonic acid.

30. The method of claim 2 wherein the composition consists essentially of:
the phosphonic acid;
an organic solvent in a concentration of less than about 30 vol. %; and
the water.

31. The method of claim 30 wherein the phosphonic acid compound has a general formula CH₃(CH₂)ₙP(O)(OH)₂ wherein n is in the range 5 to 17.

32. The method of claim 30 wherein the phosphonic acid compound is octylphosphonic acid.

33. The method of claim 2 wherein the composition consists essentially of:
the phosphonic acid;
an organic solvent in a concentration of less than about 5 vol. %; and
the water.

34. The method of claim 33 wherein the phosphonic acid compound has a general formula CH₃(CH₂)ₙP(O)(OH)₂ wherein n, is in the range 5 to 17.

35. The method of claim 33 wherein the phosphonic acid compound is octylphosphonic acid.

36. The method of claim 2 wherein the composition consists essentially of:
the phosphonic acid;
an alcohol in a concentration of less than about 30 vol. %; and
the water.

37. The method of claim 36 wherein the phosphonic acid compound has a general formula CH₃(CH₂)ₙP(O)(OH)₂ wherein n is in the range 5 to 17.

38. The method of claim 36 wherein the phosphonic acid compound is octylphosphonic acid.

39. The method of claim 2 wherein the composition consists essentially of:
the phosphonic acid;
an alcohol in a concentration of less than about 5 vol. %; and
the water.

40. The method of claim 39 wherein the phosphonic acid compound has a general formula CH₃(CH₂)ₙP(O)(OH)₂ wherein n is in the range 5 to 17.

41. The method of claim 39 wherein the phosphonic acid compound is octylphosphonic acid.

42. The method of claim 2 wherein the composition consists essentially of:
the phosphonic acid;
ethanol in a concentration of less than about 30 vol. %; and
the water.

43. The method of claim 42 wherein the phosphonic acid compound has a general formula CH₃(CH₂)ₙP(O)(OH)₂ wherein n is in the range 5 to 17.

44. The method of claim 42 wherein the phosphonic acid compound is octylphosphonic acid.

45. The method of claim 2 wherein the composition consists essentially of:
the phosphonic acid;
ethanol in a concentration of less than about 5 vol. %; and
the water.

46. The method of claim 45 wherein the phosphonic acid compound has a general formula CH₃(CH₂)ₙP(O)(OH)₂ wherein n is in the range 5 to 17.

47. The method of claim 45 wherein the phosphonic acid compound is octylphosphonic acid.

48. The method of claim 2 wherein the composition is free of organic solvent and consists essentially of:
the phosphonic acid; and
the water.

49. The method of claim 48 wherein the phosphonic acid compound has a general formula CH₃(CH₂)ₙP(O)(OH)₂ wherein n is in the range 5 to 17.

50. The method of claim 48 wherein the phosphonic acid compound is octylphosphonic acid.

51. The method of claim 2 wherein the composition comprises the phosphonic acid in a concentration between about 0.01 and about 10% w/v.

52. The method of claim 51 wherein the phosphonic acid compound has a general formula CH₃(CH₂)ₙP(O)(OH)₂ wherein n is in the range 5 to 17.

53. The method of claim 51 wherein the phosphonic acid compound is octylphosphonic acid.

54. The method of claim 6 wherein the composition comprises the phosphonic acid in a concentration between about 0.01 and about 10% w/v.

55. The method of claim 54 wherein the phosphonic acid compound has a general formula CH₃(CH₂)ₙP(O)(OH)₂ wherein n is in the range 5 to 17.

56. The method of claim 54 wherein the phosphonic acid compound is octylphosphonic acid.

57. The method of claim 9 wherein the composition comprises the phosphonic acid in a concentration between about 0.01 and about 10% w/v.

58. The method of claim 57 wherein the phosphonic acid compound has a general formula CH₃(CH₂)ₙP(O)(OH)₂ wherein n is in the range 5 to 17.

59. The method of claim 57 wherein the phosphonic acid compound is octylphosphonic acid.

60. The method of claim 2 wherein the workpiece is an electronic component with the tin-based surface thereon, and the method comprises contacting the tin-based surface on the electronic component with the composition comprising the phosphonic acid compound and the water to form the phosphorus-based film over the tin-based surface thereby inhibiting corrosion of the tin-based surface.

61. The method of claim 2 wherein the workpiece is an electronic component with the tin-based surface thereon for providing a solderable surface in a soldering operation, and the method comprises contacting the tin-based surface on the electronic component with the composition comprising the phosphonic acid compound and the water to form the phosphorus-based film over the tin-based surface thereby inhibiting corrosion of the tin-based surface and preserving solderability of the tin-based coating on the electronic component during storage prior to a soldering operation involving reflow of a portion of the tin-based surface.

62. The method of claim 61 wherein the phosphonic acid compound has the general formula CH₃(CH₂)ₙP(O)(OH)₂ wherein n is in the range 5 to 17.

63. The method of claim 61 wherein the phosphonic acid compound is octylphosphonic acid.

64. The method of claim 61 wherein the composition comprises:
the phosphonic acid compound;
an organic solvent in a concentration of less than about 30 vol. %; and
the water.

65. The method of claim 64 wherein the phosphonic acid compound has a general formula CH₃(CH₂)ₙP(O)(OH)₂ wherein n is in the range 5 to 17.

66. The method of claim 64 wherein the phosphonic acid compound is octylphosphonic acid.

67. The method of claim 61 wherein the composition comprises:
the phosphonic acid compound;
an organic solvent in a concentration of less than about 5 vol. %; and
the water.

68. The method of claim 67 wherein the phosphonic acid compound has a general formula CH₃(CH₂)ₙP(O)(OH)₂ wherein n is in the range 5 to 17.

69. The method of claim 67 wherein the phosphonic acid compound is octylphosphonic acid.

70. The method of claim 61 wherein the composition comprises:
the phosphonic acid compound;
an alcohol in a concentration of less than about 30 vol. %; and
the water.

71. The method of claim 70 wherein the phosphonic acid compound has a general formula CH₃(CH₂)ₙP(O)(OH)₂ wherein n is in the range 5 to 17.

72. The method of claim 70 wherein the phosphonic acid compound is octylphosphonic acid.

73. The method of claim 61 wherein the composition comprises:
the phosphonic acid compound;
an alcohol in a concentration of less than about 5 vol. %; and
the water.

74. The method of claim 73 wherein the phosphonic acid compound has a general formula CH₃(CH₂)ₙP(O)(OH)₂ wherein n is in the range 5 to 17.

75. The method of claim 73 wherein the phosphonic acid compound is octylphosphonic acid.

76. The method of claim 61 wherein the composition comprises:
the phosphonic acid compound;
ethanol in a concentration of less than about 30 vol. %; and
the water.

77. The method of claim 76 wherein the phosphonic acid compound has a general formula CH₃(CH₂)ₙP(O)(OH)₂ wherein n is in the range 5 to 17.

78. The method of claim 76 wherein the phosphonic acid compound is octylphosphonic acid.

79. The method of claim 61 wherein the composition comprises:
the phosphonic acid compound;
ethanol in a concentration of less than about 5 vol. %; and
the water.

80. The method of claim 79 wherein the phosphonic acid compound has a general formula CH₃(CH₂)ₙP(O)(OH)₂ wherein n is in the range 5 to 17.

81. The method of claim 79 wherein the phosphonic acid compound is octylphosphonic acid.

82. The method of claim 61 wherein the composition is free of organic solvent and comprises the phosphonic acid and the water.

83. The method of claim 82 wherein the phosphonic acid compound has a general formula CH₃(CH₂)ₙP(O)(OH)₂ wherein n is in the range 5 to 17.

84. The method of claim 82 wherein the phosphonic acid compound is octylphosphonic acid.

85. The method of claim 61 wherein the composition consists essentially of the phosphonic acid and the water.

86. The method of claim 85 wherein the phosphonic acid compound has a general formula CH₃(CH₂)ₙP(O)(OH)₂ wherein n is in the range 5 to 17.

87. The method of claim 85 wherein the phosphonic acid compound is octylphosphonic acid.

88. The method of claim 61 wherein the composition consists essentially of:
the phosphonic acid;
an organic solvent in a concentration of less than about 30 vol. %; and
the water.

89. The method of claim 88 wherein the phosphonic acid compound has a general formula CH₃(CH₂)ₙP(O)(OH)₂ wherein n is in the range 5 to 17.

90. The method of claim 88 wherein the phosphonic acid compound is octylphosphonic acid.

91. The method of claim 61 wherein the composition consists essentially of:
the phosphonic acid;
an organic solvent in a concentration of less than about 5 vol. %; and
the water.

92. The method of claim 91 wherein the phosphonic acid compound has a general formula CH₃(CH₂)ₙP(O)(OH)₂ wherein n is in the range 5 to 17.

93. The method of claim 91 wherein the phosphonic acid compound is octylphosphonic acid.

94. The method of claim 61 wherein the composition consists essentially of:
the phosphonic acid;
an alcohol in a concentration of less than about 30 vol. %; and
the water.

95. The method of claim 94 wherein the phosphonic acid compound has a general formula CH₃(CH₂)ₙP(O)(OH)₂ wherein n is in the range 5 to 17.

96. The method of claim 94 wherein the phosphonic acid compound is octylphosphonic acid.

97. The method of claim 61 wherein the composition consists essentially of:
the phosphonic acid;
an alcohol in a concentration of less than about 5 vol. %; and
the water.

98. The method of claim 97 wherein the phosphonic acid compound has a general formula CH₃(CH₂)ₙP(O)(OH)₂ wherein n is in the range 5 to 17.

99. The method of claim 97 wherein the phosphonic acid compound is octylphosphonic acid.

100. The method of claim 61 wherein the composition consists essentially of:
the phosphonic acid;
ethanol in a concentration of less than about 30 vol. %; and
the water.

101. The method of claim 100 wherein the phosphonic acid compound has a general formula CH₃(CH₂)ₙP(O)(OH)₂ wherein n is in the range 5 to 17.

102. The method of claim 100 wherein the phosphonic acid compound is octylphosphonic acid.

103. The method of claim 61 wherein the composition consists essentially of:
the phosphonic acid;
ethanol in a concentration of less than about 5 vol. %; and
the water.

104. The method of claim 103 wherein the phosphonic acid compound has a general formula CH₃(CH₂)ₙP(O)(OH)₂ wherein n is in the range 5 to 17.

105. The method of claim 103 wherein the phosphonic acid compound is octylphosphonic acid.

106. The method of claim 61 wherein the composition is free of organic solvent and consists essentially of:
the phosphonic acid; and
the water.

107. The method of claim 106 wherein the phosphonic acid compound has a general formula CH₃(CH₂)ₙP(O)(OH)₂ wherein n is in the range 5 to 17.

108. The method of claim 106 wherein the phosphonic acid compound is octylphosphonic acid.

109. The method of claim 61 wherein the composition comprises the phosphonic acid in a concentration between about 0.01 and about 10% w/v.

110. The method of claim 109 wherein the phosphonic acid compound has a general formula CH₃(CH₂)ₙP(O)(OH)₂wherein n is in the range 5 to 17.

111. The method of claim 109 wherein the phosphonic acid compound is octylphosphonic acid.

112. The method of claim 64 wherein the composition comprises the phosphonic acid in a concentration between about 0.01 and about 10% w/v.

113. The method of claim 112 wherein the phosphonic acid compound has a general formula CH₃(CH₂)ₙP(O)(OH)₂ wherein n is in the range 5 to 17.

114. The method of claim 112 wherein the phosphonic acid compound is octylphosphonic acid.

115. The method of claim 67 wherein the composition comprises the phosphonic acid in a concentration between about 0.01 and about 10% w/v.

116. The method of claim 115 wherein the phosphonic acid compound has a general formula CH₃(CH₂)ₙP(O)(OH)₂ wherein n is in the range 5 to 17.

117. The method of claim 115 wherein the phosphonic acid compound is octylphosphonic acid.

118. A composition for enhancing corrosion resistance of a tin-based surface on a workpiece comprising:
a concentration between about 0.01 and about 10% w/v of a phosphonic acid compound of the formula: 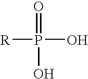
where R is hydrocarbyl or substituted hydrocarbyl and the H ions can be replaced by sodium or potassium to produce a phosphonate salt;
a concentration up to about 30 vol. % of an organic solvent; and
water.

119. The composition of claim 118 wherein the phosphonic acid compound has the general formula CH₃(CH₂)ₙP(O)(OH)₂ wherein n is in the range 5 to 17.

120. The composition of claim 118 wherein the phosphonic acid compound is octylphosphonic acid.

121. A composition for enhancing corrosion resistance of a tin-based surface on a workpiece comprising:
a concentration between about 0.01 and about 10% w/v of a phosphonic acid compound of the formula: 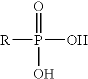
where R is hydrocarbyl or substituted hydrocarbyl and the H ions can be replaced by sodium or potassium to produce a phosphonate salt; and
water;
wherein the composition is free of organic solvents.

122. The composition of claim 121 wherein the phosphonic acid compound has the general formula CH₃(CH₂)ₙP(O)(OH)₂ wherein n is in the range 5 to 17.

123. The composition of claim 121 wherein the phosphonnic acid compound is octylphosphonic acid.

124. A composition for enhancing corrosion resistance of a tin-based surface on a workpiece consisting essentially of:
a concentration between about 0.01 and about 10% w/v of a phosphonic acid compound of the formula: 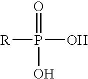
where R is hydrocarbyl or substituted hydrocarbyl and the H ions can be replaced by sodium or potassium to produce a phosphonate salt;
a concentration up to about 30 vol. % of an organic solvent; and
water.

125. The composition of claim 124 wherein the phosphonic acid compound has the general formula CH₃(CH₂)ₙP(O)(OH)₂ wherein n is in the range 5 to 17.

126. The composition of claim 124 wherein the phosphonic acid compound is octylphosphonic acid.

127. A composition for enhancing corrosion resistance of a tin-based surface on a workpiece consisting essentially of:
a concentration between about 0.01 and about 10% w/v of a phosphonic acid compound of the formula: 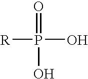
where R is hydrocarbyl or substituted hydrocarbyl and the H ions can be replaced by sodium or potassium to produce a phosphonate salt; and
water;
wherein the composition is free of organic solvents.

128. The composition of claim 127 wherein the phosphonic acid compound has the general formula CH₃(CH₂)ₙP(O)(OH)₂ wherein n is in the range 5 to 17.

129. The composition of claim 128 wherein the phosphonnic acid compound is octylphosphonic acid.
